(19) United States
(12) Patent Application Publication
(10) Pub. No.: US 2014/0163950 A1
(43) Pub. Date: Jun. 12, 2014

(54) TRANSLATION SYSTEM AND METHOD THEREOF

(71) Applicants: INVENTEC (PUDONG) TECHNOLOGY CORPORATION, (US); INVENTEC CORPORATION, Taipei (TW)

(72) Inventor: Sean LIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/803,414

(22) Filed: Mar. 14, 2013

(30) Foreign Application Priority Data
Dec. 6, 2012 (CN) 201210520171.8

(51) Int. Cl. G06F 17/28

(52) U.S. Cl. CPC G06F 17/28
USPC 704/3

(57) ABSTRACT

A system for translating multiple words at one time and a method thereof are provided. Through the technical means of selecting multiple words and, translating the selected words in the background, and simultaneously displaying translations of all the selected words, the query for the translations of the words does not break reading, and the technical efficacy of helping a user to understand the document content more quickly is achieved.

### BACKGROUND OF THE INVENTION

1. Field of the Invention

The present invention relates to a translation system and a method thereof, and more particularly to a system for translating multiple words at one time and a method thereof.

2. Description of Related Art

Nowadays, more and more work can be done on a digital device, for example, editing or reading documents, and electronic transactions.

It is inconvenient to carry a paper dictionary, so a user of a digital device usually installs an electronic dictionary in the digital device. Hence, if the user comes across a word beyond understanding while reading a document on the digital device, the user can look up the electronic dictionary for the word, so as to understand the meaning of the word. Nevertheless, before looking up the electronic dictionary for the word, the user often has to stop reading. As a result, the user cannot read the document consistently, which increases the time for reading the document.

In addition, all the current electronic dictionaries simply provide a function of single-word lookup, so the user cannot look up for translations of multiple words simultaneously. As a result, when the words to be looked up for are associated with each other, the user has to search for the translations of these words repeatedly, so as to determine the translations fit for these words. However, the user is likely to be disturbed by the repeated lookup process, and meanwhile it takes more time for the user to understand the document.

To sum up, for a long time, the prior art has the following problem: the reading process is interrupted by the use of the electronic dictionary and associated words need to be looked up for repeatedly, so it is necessary to provide an improvement technical means to solve this problem.

### SUMMARY OF THE INVENTION

In view of the problem that the reading process is interrupted by the use of an electronic dictionary and that associated words need to be looked up for repeatedly in the prior art, the present invention discloses a system for translating multiple words at one time and a method thereof.

The translation system for translating multiple words at one time disclosed in the present invention at least includes: an input module, used for selecting words from a document displayed on a display screen; a storage module, used for copying the words to a translation area; a translation module, used for translating, in a background, the words in the translation area simultaneously; and a display module, used for displaying translations of the words on the display screen simultaneously.

The translation method for translating multiple words at one time disclosed in the present invention at least includes steps of: selecting a first word from a document displayed on a display screen; copying the first word to a translation area; selecting a second word from the document; copying the second word to the translation area; translating the first word and the second word in the translation area simultaneously; and displaying translations of the first word and the second word on the display screen simultaneously.

The system and the method disclosed in the present invention are described above, and the difference between the present invention and the prior art lies in that, by selecting multiple words, translating the selected words in the background simultaneously, and simultaneously displaying the translations of all the selected words, the present invention solves the problem in the prior art, and achieves the technical efficacy of helping a user to understand document content more quickly.

### BRIEF DESCRIPTION OF THE DRAWINGS

FIG. 1 is an architectural diagram of a translation system according to the present invention.

FIG. 2 is a flow chart of a translation method according to the present invention.

FIG. 3A is a schematic diagram of selecting words according to the present invention.

FIG. 3B is a schematic diagram of displaying words according to the present invention.

### DESCRIPTION OF THE EMBODIMENTS

Features and implementation manners of the present invention are illustrated in detail below with reference to accompanying drawings and embodiments. The content is sufficient for those skilled in the art to easily and fully understand and implement the technical means applied in the present invention to solve the technical problem, thereby achieving the efficacy of the present invention.

The present invention can translate multiple words selected by a user, and display translations, so that the user can continuously browsing document without any interruption while the words are translated by means of the present invention. The translations provided by the present invention are data that enables the user to understand the meaning, definition or connotation of the words, for example, the spelling, part of speech, descriptions and example sentences of the words.

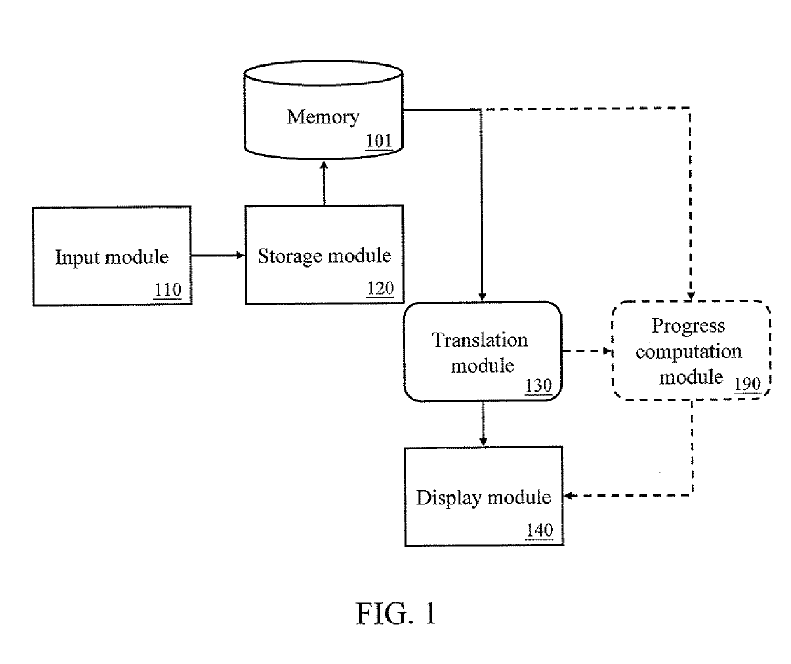

The operation of the system of the present invention is illustrated below with reference to FIG. 1. FIG. 1 is an architectural diagram of a translation system according to the present invention. As shown in FIG. 1, the system of the present invention includes an input module 110, a storage module 120, a translation module 130 and a display module 140.

The input module 110 is responsible for providing selecting multiple words from document, where the document including the words is displayed on a display screen (not shown) of a device performing the present invention.

A first selected word in the document is referred to as a “first word” in the present invention, while a second selected word, a third selected word and subsequently selected words are referred to as “second words”. For the convenience of description, the first word or the second words are expressed as words in the present invention.

The input module 110 may provide marking the words in the document, so as to select the words from the document. The input module 110 may also provide inputting an instruction for copying the words, and the input module 110 may even compute a stay time of a cursor on the display screen. When the stay time computed by the input module 110 reaches a certain value, the input module 110 may detect a word selection range according to a position of the cursor, and use words in the word selection range as the words, where the input module 110 may detect blank characters arranged before and after the cursor position and closest to the cursor position. As a result, a range between the detected blank characters is the word selection range. The input module 110 may also detect a complete sentence including a word overlapping with the cursor, where the detected complete sentence is the word selection range. However, the way in which the input module 110 selects the words is not limited thereto.

The input module 110 is responsible for triggering a translation event in the display screen where the document is displayed by the device performing the present invention. The input module 110 may provide operating manners such as click, double click and/or long click in the display screen where the document is displayed, so as to select objects such as a specific button on the display screen, so that the translation event is triggered. However, the manner of triggering the translation event provided by the input module 110 is not limited thereto.

The storage module 120 is responsible for copying the words selected by the input module 110 to a translation area. In general, the translation area for storing the words is a storage area in a memory 101 of the device performing the present invention, but the present invention is not limited thereto. For example, the translation area may also be a storage area in a hard disk of the device performing the present invention, and so on.

In some embodiments, the storage module 120 may also store the words selected by the input module 110 to a history record file, so as to record the words as history records of query.

The translation module 130 is responsible for simultaneously translating, after the translation event is triggered, the words stored in the translation area by the storage module 120. In some embodiments, the translation module 130 may use multiple threads to respectively and simultaneously translate different words. For example, the translation module 130 uses threads with same number as the words in the translation area to translate the words, where each thread translates one word. However, the number of the threads used in the present invention is not limited thereto. In another example, the translation module 130 uses a fixed number of threads to translate the words in the translation area. When the number of the words is more than that of the threads, a thread that finishes translating one word will continue to translate another word to be translated in the translation area. In general, the translation module 130 translates, in the background of the display screen, the words stored in the translation area, but the present invention is not limited thereto. The translation module 130 may also translate, on the display screen, the words in the translation area.

The display module 140 is responsible for simultaneously displaying, on the display screen displayed by the device performing the present invention, the translations of the words translated by the translation module 130. In general, the display module 140 displays the translations of the words when the translation event in the display screen is triggered, but the present invention is not limited thereto.

The display module 140 may display the translations of the words on the document in an overlapping manner, for example, displaying the translations on the display screen through a floating window. The display module 140 may also display the document and the translations of the words side by side, for example, displaying the translations and the document at the top and bottom or the left and right of the display screen respectively, but the manner in which the display module 140 displays the translations of the words is not limited thereto. All manners for displaying the translations of the words and the document simultaneously can be used in the present invention. It should be noted that, the display module 140 usually displays the translations of the words in a centralized manner, for example, displaying the translations in the same floating window in a centralized manner, or displaying the translations at the top or right of the display screen in a centralized manner, and so on, but the present invention is not limited thereto.

In some embodiments, the display module 140 may display, on the display screen displayed by the device performing the present invention, the words stored in the translation area by the storage module 120. Similar to the manner of displaying the translations of the words, the display module 140 may display, on the display screen, the words stored in the translation area on the document in an overlapping manner or side by side with the document. The present invention does not define any particular display manner. All manners for simultaneously displaying the translations of the words and the document can be used in the present invention.

In addition, the present invention may further include an attachable progress computation module 190. The progress computation module 190 computes a progress of the translation module 130 in translating the words. The display module 140 is further used for displaying, on the display screen displayed by the device performing the present invention, the progress computed by the progress computation module 190. In the present invention, the progress computed by the progress computation module 190 is referred to as a “translation progress”.

In general, the progress computation module 190 computes the number of the words translated by the translation module 130 as the translation progress, but the present invention is not limited thereto. All data capable of enabling the user to know when the translation module 130 may finish the translation of the words can be used as the translation progress of the present invention.

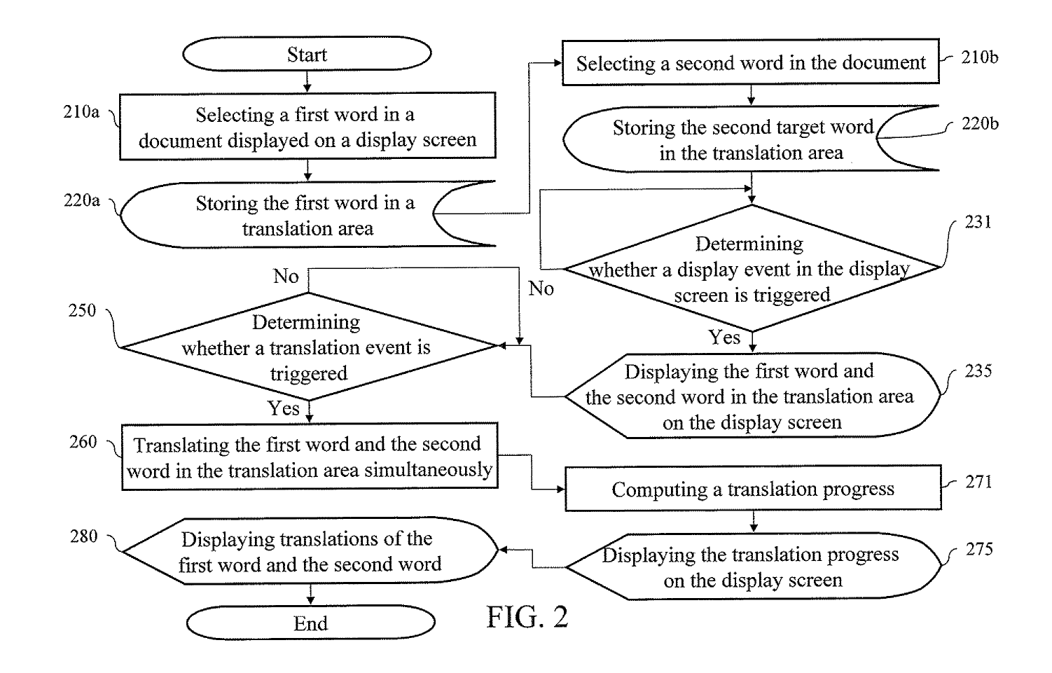

The operation system and method of the present invention are illustrated through an embodiment below and with reference to FIG. 2. FIG. 2 is a flow chart of a translation method according to the present invention. In this embodiment, the present invention is included in translation software. The translation software including the present invention is performed on a computer.

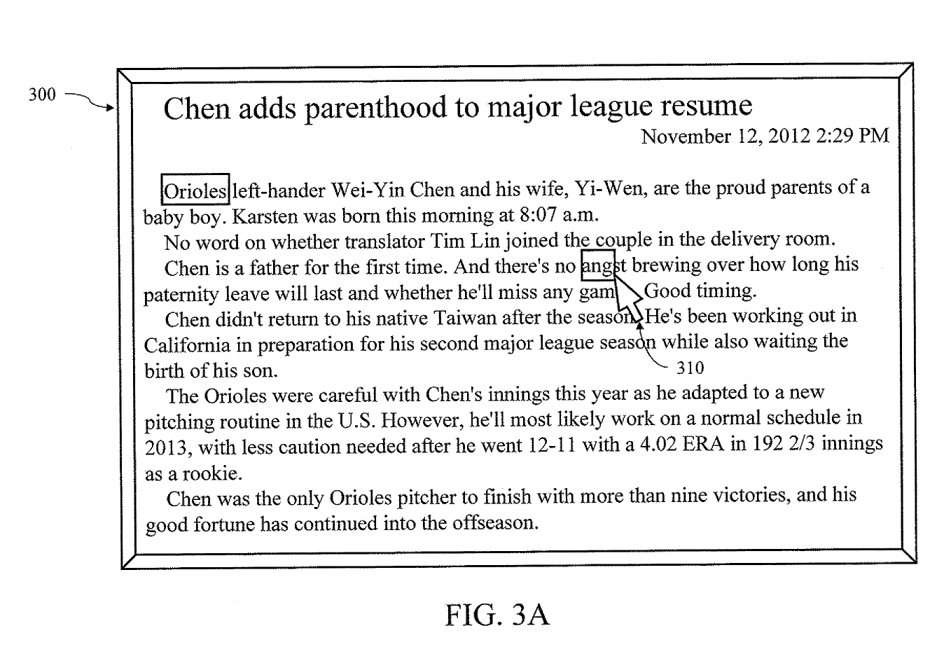

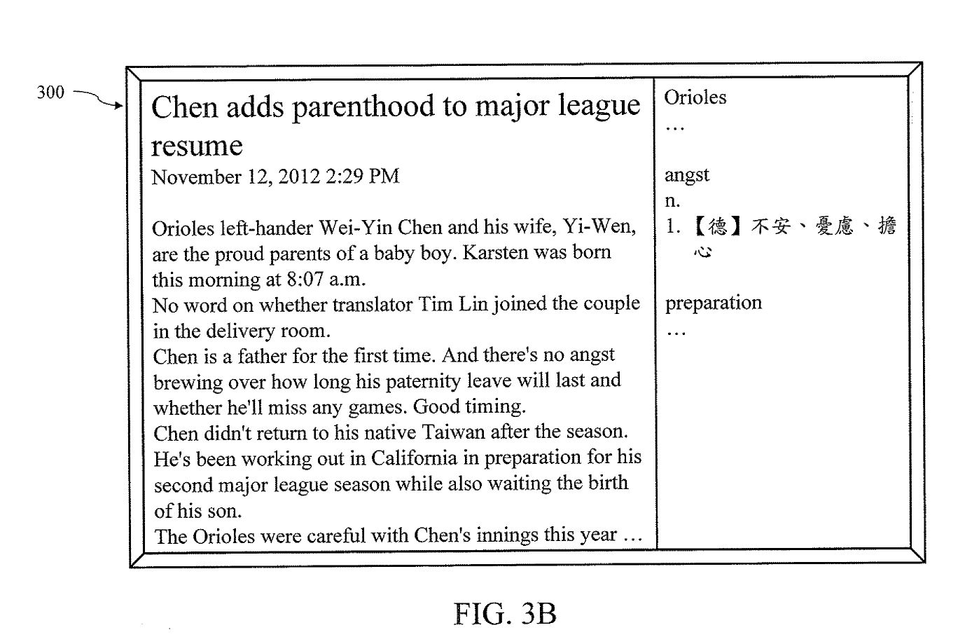

First, the computer displays all or a part of document on a display screen; an input module 110 may provide an option for a user to select a first word from the document displayed on the display screen (step 210a). In this embodiment, the input module 110 may, as shown in FIG. 3A, enable the user to move a mouse after pressing the mouse, so as to control a cursor 310 to select a word “Orioles” on the document displayed on the display screen 300.

After the user selects, through the input module 110, the first word from the document displayed on the display screen (step 210a), a storage module 120 may store the first word, selected by the user under the effect of the input module 110, to a translation area (step 220a). In this embodiment, it is assumed that the translation area is a storage area of a memory of the computer.

Then, the input module 110 may continue provide an option for the user to select a second word in the document displayed on the display screen (step 210b). In this embodiment, it is assumed that the user is selecting the second word “angst” through the input module 110.

After the user selects, through the input module 110, the second word from the document displayed on the display screen (step 210b), the storage module 120 may store the second word to the translation area (step 220b). In other words, the storage module 120 copies the words selected by the user to the translation area each time after the user selects the words through the input module 110. Hence, the translation area stores a list of the words selected by the user.

In practice, the user may continue to select the second word through the input module 110 (step 210b), and the storage module 120 may store the second word to the translation area (220b), until the user finishes selecting the words.

After the user finishes selecting the words, the user may trigger a translation event through the input module 110. In this embodiment, it is assumed that the input module 110 enables the user to click a translation icon on the display screen. After the translation icon is clicked, the translation event is triggered.

When a translation module 130 determines that the translation event is triggered (step 250), the translation module 130 may simultaneously translate the first word and the second word stored in the translation area (step 260). In this embodiment, the translation module 130 uses multiple threads to translate the words stored in the translation area, and produces a translation of each word.

After the translation module 130 simultaneously translates the first word and the second word stored in the translation area (step 260), a display module 140 may display, on the display screen, the translations of the first word and the second word produced by the translation module 130 (step 280). In this embodiment, it is assumed that, after the user triggers a display event through the input module 110, for example, after the input module 110 enables the user to click an icon for displaying the translations, the display module 140 displays, on the display screen 300 side by side in a centralized manner, the translations of the words stored in the translation area and translated by the translation module 130, as shown in FIG. 3B. (The Chinese characters shown in the FIG. 3B are just mentioned for describing the embodiments and are substantially irrelevant to any technical matters.) By means of the present invention, the user can select multiple words to be translated from the document all at one time, and view the translations of the selected words without translating the word each time coming across one.

In the foregoing embodiment, after the storage module 120 stores the first word/the second word, selected by the user under the effect of the input module 110, to the translation area (step 220a/b), the display module 140 may determine whether the display event in the display screen is triggered (step 231); when the display event in the display screen is trigged, the display module 140 may arrange and display, on the display screen, the first word and the second word stored in the translation area according to a stored order of the words in the translation area (step 235), so that the user may know the words currently stored in the translation area, thereby ensuring that the words stored in the translation area include the words the user intends to translate.

In addition, if the translation software of the foregoing embodiment includes a progress computation module 190, the progress computation module 190 may compute a translation progress of all the words stored in the translation area (step 271) when the translation module 130 translates the words in the translation area, and the display module 140 displays the translation progress computed by the progress computation module 190 on the display screen (step 275). In this embodiment, it is assumed that the progress computation module 190 computes the number of the words translated by the translation module 130, so that the display module 140 displays, on the display screen, the number computed by the progress computation module 190 and the number of the words stored in the translation area, for example 2/8, so that the user may know whether the translation module 130 has finished the translation, so as to enable the user to trigger the display event to view the translations of the words immediately after the translation module 130 finishes the translation.

To sum up, the difference between the present invention and the prior art lies in that the present invention has the technical means of providing selecting multiple words and, after translating the selected words, simultaneously displaying the translations of all the selected words. The technical means solves the problem that the reading process is interrupted by the use of an electronic dictionary and that associated words need to be looked up for repeatedly in the prior art, thereby achieving the technical efficacy of helping the user to understand the document content more quickly.

Moreover, the translation method according to the present invention may be implemented in hardware, software or a combination thereof, and may also be implemented in a computer system in a centralized manner, or in different elements distributed several interconnected computer systems in a decentralized manner.

What is claimed is:

1. A translation method, comprising steps of:
selecting a first word in a document which is displayed on a display screen;
storing the first word in a translation area;
selecting a second word in the document.
storing the second word in the translation area;
translating the words in the translation area simultaneously, that is, translating the first word and the second word simultaneously; and
displaying translation of the first word and translation of the second word simultaneously.

2. The translation method according to claim 1, after the step of storing the second word in the translation area, further comprising a step of displaying the first word and the second word in the translation area on the display screen when a display event in the display screen is triggered.

3. The translation method according to claim 1, wherein the step of translating the words in the translation area simultaneously is translating the first word and the second word through multiple threads respectively and simultaneously.

4. The translation method according to claim 1, further comprising a step of computing a translation progress when the translating the words, and displaying the translation progress on the display screen.

5. The translation method according to claim 1, wherein the step of selecting the first word in the document which is displayed on the display screen or selecting the second word in the document is: providing marking the first word/the second word in the document, providing inputting an instruction for storing the first word/the second word, or computing a stay time of a cursor on the display screen, and when the stay time reaches a certain value, detecting a word selection range according to a position of the cursor, and using a word in the word selection range as the first word/the second word.

6. A translation system, comprising:
an input module, used for selecting a first word and a second word in a document which the document is displayed on a display screen;
a storage module, used for storing the first word and the second word in a translation area;
a translation module, used for translating the words in the translation area simultaneously, that is, translating the first word and the second word in the translation area simultaneously; and
a display module, used for displaying translation of the first word and translation of the second word simultaneously.

7. The translation system according to claim 6, wherein the display module is further used for displaying the first word and the second word when a display event in the display screen is triggered.

8. The translation system according to claim 6, wherein the translation module translates the first word and the second word through multiple threads respectively and simultaneously.

9. The translation system according to claim 6, further comprising a progress computation module, used for computing a translation progress, wherein the display module is further used for displaying the translation progress on the display screen.

10. The translation system according to claim 6, wherein the storage module is further used for recording the first word and the second word as historical records.
